(19) United States
(12) Patent Application Publication
(10) Pub. No.: US 2010/0185395 A1
(43) Pub. Date: Jul. 22, 2010

(54) SELECTING OPTIMAL WELLBORE TRAJECTORY WHILE DRILLING

(76) Inventors: Dimitiros K. Pirovolou, Houston, TX (US); Jean-Michel Denichou, Beijing (CN)

Correspondence Address: SCHLUMBERGER OILFIELD SERVICES, 200 GILLINGHAM LANE, MD 200-9, SUGAR LAND, TX, 77478, US

(21) Appl. No.: 12/357,612

(22) Filed: Jan. 22, 2009

(51) Int. Cl. G01V 9/00; G06F 19/00

(52) U.S. Cl. 702/9

(57) ABSTRACT

A method for selecting an optimal trajectory of a wellbore while drilling the wellbore and a computer program having instructions for the same are disclosed. The method and program may include obtaining data, such as real-time date, related to the wellbore and obtaining data related to drilling limitations. The method and program also obtains data related to production considerations or drilling considerations. A target is selected and the optimal trajectory is selected from possible trajectories to the target. Ideally, the optimal trajectory conforms with the drilling limitations and satisfies one or more of the production considerations or drilling considerations.

### TECHNICAL FIELD

The present invention generally relates to wellbore operations and more specifically to a method and system for altering a wellbore trajectory while drilling.

### BACKGROUND

Traditional wellbore drilling practices attempted to drill wells as near to the vertical as possible. However, over the past 25 years, it has become common to drill directional or slanted wells in order to gain access to hydrocarbon deposits located underneath ground sites, where it was not feasible to set up a drilling rig. Directional drilling is the process of directing the drill bit along a defined trajectory to a predetermined target. Because of these directional drilling capabilities, strong economic and environmental pressures have increased the desire for and use of directional drilling. As a result of these pressures, directional drilling is being applied in situations where it has not been common in the past. These new applications have caused wellbore trajectories to become increasingly more complex.

The location of the trajectory of a wellbore is determined by computing Cartesian coordinates from a set of curvilinear coordinates defined by a set of survey stations at various depths in the earth. Each survey station comprises a depth measurement from the surface, an inclination, and an azimuth at a location along a well path. To convert information from the survey stations into a well path in terms of curvilinear coordinates some method is implemented which makes a set of assumptions about the well path. The set of assumptions are related to the well path between the survey stations. Several methods related to processing a well plan have been used to date including average angle, tangential, balanced tangential, Mercury, radius of curvature, and minimum curvature. Only the radius of curvature method and the minimum curvature method produce a path that is acceptable for highly directional wells.

In recent years, well plans have become much more complex due to the reduction in technological limitations which have made such well plans difficult, if not impossible, to drill using previous or conventional technologies. The complexity of these designer wells has forced well planners to use planning tools that are in turn becoming more complex.

Today, well planning is typically accomplished by plotting together a series of curve and hold sections using a spreadsheet on which each row represents an individual section of the well. The trajectory planning workflow is usually performed by adding sections, plotting the sections, editing numbers on the spreadsheet, and again plotting the sections. This procedure is conducted repeatedly until well planners obtain a satisfactory trajectory. With the ever increasing three dimensional (3D) nature of wells and the necessity to avoid existing wells, there remains a need for a new well planning method that can create, manipulate and edit well plans.

After drilling commences however, it is often realized that the preplanned trajectory will not arrive at the desired target(s) and that the trajectory must be corrected. Alternatively, it may be determined that the desired target has changed and the trajectory should change to reach the new target. Further, it may be determined that there is an improved trajectory to reach the desired target.

It is a desire to provide a method and system for selecting and drilling along an optimal corrected trajectory. The optional trajectories may be analyzed and compared based on various drilling and/or trajectory parameters to determine a cost function associated with each possible path. In some embodiments the parameters may include without limitation dog-leg severity, torque and drag, and drilling rig requirements and/or limitations.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 illustrates an embodiment of a drilling system of the present invention string;

FIG. 2 is a diagrammatic illustration of an automated system that can be utilized to acquire and manipulate data, according to an embodiment of the present invention;

FIG. 3 is conceptual illustration of a wellbore being drilled in accordance with an embodiment of the present invention; and

FIG. 4 is a block diagram illustrating one method for optimizing a wellbore trajectory while drilling in accordance with an embodiment of the present invention.

### DETAILED DESCRIPTION

Refer now to the drawings wherein depicted elements are not necessarily shown to scale and wherein like or similar elements are designated by the same reference numeral through the several views.

As used herein, the terms “up” and “down”; “upper” and “lower”; and other like terms indicating relative positions to a given point or element are utilized to more clearly describe some elements of the embodiments of the invention. Commonly, these terms relate to a reference position from the surface from which drilling operations are initiated as being the top position or the surface position.

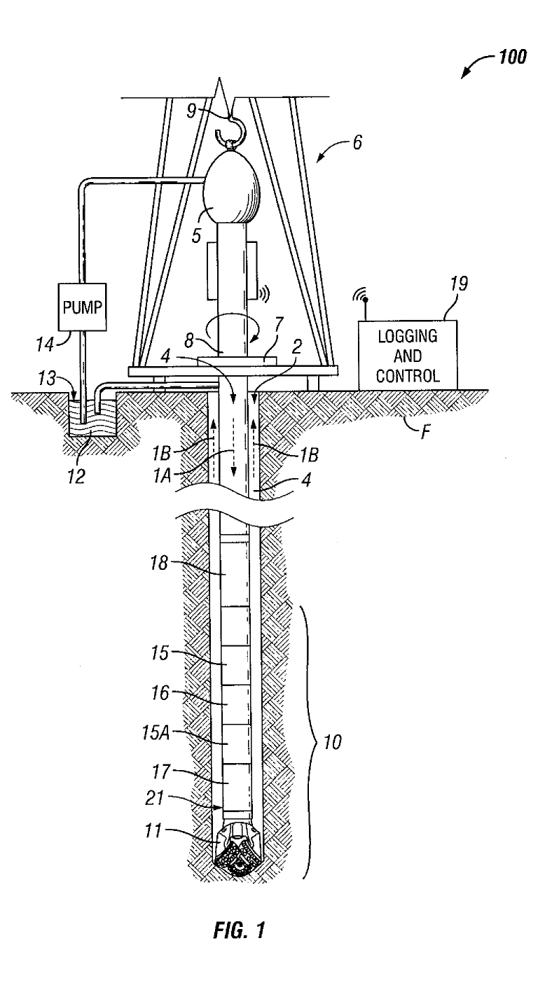

FIG. 1 illustrates a well system 100 in which the present invention may be employed. The well system 100 comprises a surface assembly 6 that is positionable at various locations, such as onshore or offshore. In this exemplary system, a borehole or wellbore 2 is formed in a subsurface formation(s), generally denoted as F, by rotary drilling in a manner that is well known. Embodiments of the invention can also use directional drilling, as will be described hereinafter.

A drill string 4 is suspended within the wellbore 2 and has a bottomhole assembly 10 which includes a drill bit 11 at its lower end. In the embodiment of FIG. 1, the surface assembly 6 includes a rotary table 7, a kelly 8, a hook 9 and a rotary swivel 5. Drill string 4 is rotated by the rotary table 7, energized by means not shown, which engages the kelly 8 at the upper end of the drill string 4. The drill string 4 is suspended from the hook 9 that is attached to a traveling block (not shown) through the kelly 8 and the rotary swivel 5. The rotary swivel 5 may permit rotation of the drill string 4 relative to the hook 9. As is well known, a top drive system (not shown) may be used to rotate the drill string 4. In addition, a downhole motor (not shown ) may be used to rotate the drill bit 11.

In the example of this embodiment, drilling fluid or mud 12 may be stored in a tank or pit 13 at or near the wellsite. A pump 14 delivers the drilling fluid 12 to the interior of the drill string 4, such as via a port in swivel 5. The drilling fluid 12 flows downwardly through drill string 4 as indicated by directional arrow la. The drilling fluid 12 exits the drill string 4 at the drill bit 11, and then circulates generally upwardly through the annulus region between the exterior of the drill string 4 and the wall of the wellbore 2, as indicated by the directional arrows lb. In this well known manner, the drilling fluid 12 lubricates drill bit 11 and carries formation cuttings up to the surface as the drilling fluid 12. The drilling fluid 12 carrying the cuttings may be filtered, screened or otherwise treated before being returned to the pit 13 for recirculation.

The bottomhole assembly (“BHA”) 10 of the illustrated embodiment may include a logging-while-drilling (“LWD”) module 15, a measuring-while-drilling (“MWD”) module 16, a roto-steerable system (“RSS”) 17, a motor 21, and the drill bit 11. The LWD module 15 and the MWD module 16 may comprise sensors and measurement devices, which are adapted to obtain downhole data related to the formation, drilling system, wellbore fluids, formation fluids, inclinations, orientations, positions and the like. In an embodiment, the LWD module 15 may measure and record formation properties and measurements related thereto, and the MWD module 16 may measure and record drilling related measurements and directional surveying properties.

The LWD module 15 may be housed in a special type of drill collar, as is known in the art, and may contain one or more known types of logging tools. It will also be understood that more than one LWD module and/or MWD module may be employed, e.g. as represented generally at 15A. (References, throughout, to a module at the position of 15 can alternatively mean a module at the position of 15A as well.) The LWD module 15 includes capabilities for measuring, processing, and storing information, as well as for communicating with the surface equipment. In the present embodiments, the LWD module 15 may include one or more formation evaluation (FE) devices. A formation imaging device may also be included in the LWD module.

The MWD module 16 may be housed in a special type of drill collar, as is known in the art, and may contain one or more devices or sensors for measuring characteristics of the drill string and drill bit. The BHA 10 may include an apparatus (not shown) for generating electrical power to the downhole system. For example, a mud turbine may be used to generate power by the flow of the drilling fluid, however it should be understood that other power and/or battery systems may be employed. In addition, power may be provided from the surface or from a sub near the surface. In the present embodiment, the MWD module 16 includes one or more of the following types of measuring devices: a weight-on-bit measuring device, a torque measuring device, a vibration measuring device, a shock measuring device, a stick slip measuring device, a direction measuring device, and an inclination measuring device.

In an embodiment, the BHA 10 includes a surface/local communications module or package 18. The communications module 18 may provide a communications link between a controller 19, the downhole tools, sensors and the like. In the illustrated embodiment, the controller 19 may send or otherwise transmit data and signals form the surface to the drill string 4 and/or the BHA 10. The controller 19 may also receive data and signals from the drill string 4 and/or the BHA 10. In addition, the controller 19 may analyze or manipulate the data and signals from the drill string 4 and/or the BHA 10. For example, the controller 19 may receive raw data and signals from the BHA 10, analyze and manipulate the data and signals, and transmit a command to the BHA 10. The controller 19 may communicate with the drill string 4 and/or the BHA 10 wirelessly, by a wired connection or by a combination of a wired and wireless connection.

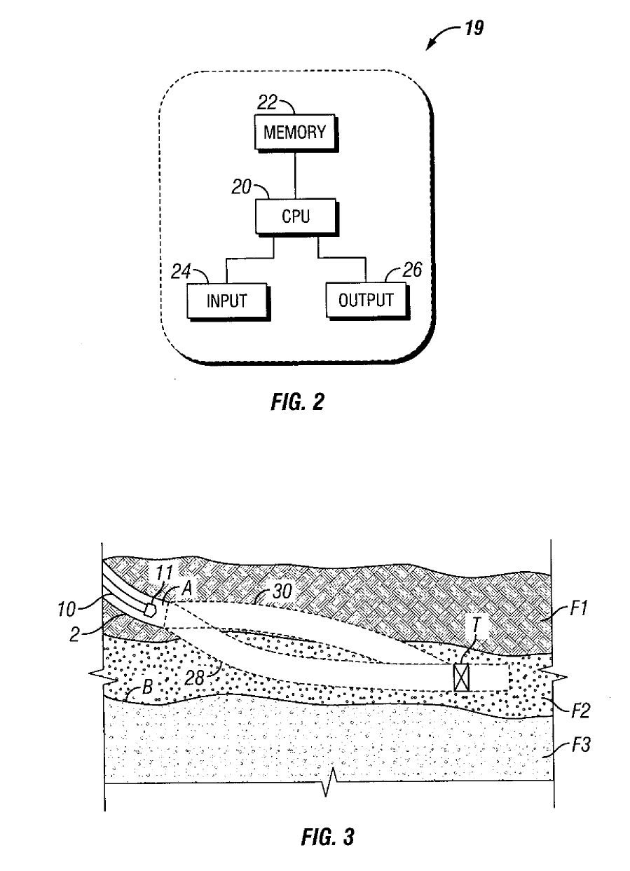

Referring to FIG. 2, in the present example, the control system 19 may be a computer-based system having a central processing unit (CPU) 20. For example, the CPU 20 may be a microprocessor-based CPU for processing data and/or signals received from the LWD module 15, the MWD module 16, data storage systems, user inputs and/or from other locations in communication with the controller 19. The data and signals may be processed, for example, via instructions stored on a database, software stored on a database, or by an operator or like individual. Furthermore, the CPU 20 may be operatively coupled and in communication with memory 22, an input device 24, and an output device 26. The input device 24 may comprise a variety of devices, such as a keyboard, mouse, voice-recognition unit, touch screen, other input devices, or combinations of such devices. The output device 26 may comprise a visual and/or an audio output device, such as a monitor having a graphical user interface. One of ordinary skill in the art will appreciate that the control system 19 may consist of a single device or multiple devices in communication.

A particularly advantageous use of the methods and systems hereof is in conjunction with “geo-steering”, which is drilling according to the geological features of the formations rather than to a predetermined geometric plan. However, one of ordinary skill in the art will appreciate that the methods and systems described may be applied to predetermined plans, such as to return the drill bit 11 to the predetermined plan. In addition, one of ordinary skill in the art will appreciate that the methods and systems described may be used in determining an optimal geometric plan before drilling the wellbore. Other uses may be readily apparent to those having ordinary skill in the art.

Geo-steering involves controlled steering or “directional drilling.” In such an embodiment, a roto-steerable subsystem 17 may be provided. Directional drilling is the intentional deviation of the wellbore from the path it would naturally take. In other words, directional drilling is the steering of the drill string 4 so that the drill string 4 travels in a desired direction. Directional drilling is, for example, advantageous in offshore drilling because it enables many wells to be drilled from a single platform. Directional drilling also enables horizontal drilling through a reservoir. Horizontal drilling enables a longer length of the wellbore to traverse the reservoir, which may increase the production rate from the well. A directional drilling system may also be used in vertical drilling operation as well. Often, the drill bit 11 may veer off of a planned drilling trajectory because of the unpredictable nature of the formations being penetrated or the varying forces experienced by the drill bit. When such a deviation occurs, a directional drilling system may be used to return the drill bit 11 to course.

A known method of directional drilling includes the use of the rotary steerable system (“RSS”) 17. In the RSS 17, downhole devices cause the drill bit 11 to drill in a desired or predetermined direction. The RSS 17 may be used to drill deviated wellbores into the earth. Example types of the RSS 17 include a “point-the-bit” system and a “push-the-bit” system. In the point-the-bit system, the axis of rotation of the drill bit 11 is deviated from the local axis of the BHA 10 in the general direction of the new hole. The borehole 2 may be propagated in accordance with the customary three point geometry defined by upper and lower stabilizer touch points and the drill bit. The angle of deviation of the axis of the drill bit 11 may be coupled with a finite distance between the drill bit 11 and lower stabilizer and may result in the non-collinear condition required for a curve to be generated. There are many ways in which this may be achieved including a fixed bend at a point in the BHA 10 adjacent to the lower stabilizer or a flexure of the drill bit drive shaft distributed between the upper and lower stabilizer. Examples of point-the-bit type rotary steerable systems, and how they operate are described in U.S. Pat. Nos. 6,401,842; 6,394,193; 6,364,034; 6,244,361; 6,158,529; 6,092,666; and 5,113,953 all herein incorporated by reference.

In the push-the-bit rotary steerable system, there is usually no specially identified mechanism to deviate the axis of the drill bit 11 from the local bottomhole assembly axis; instead, the requisite non-collinear condition may be achieved by causing either or both of the upper or lower stabilizers to apply an eccentric force or displacement in a direction that is preferentially orientated with respect to the direction of hole propagation. Again, there are many ways in which this may be achieved, including but not limited to non-rotating (with respect to the hole) eccentric stabilizers (displacement based approaches) and eccentric actuators that apply force to the drill bit in the desired steering direction. Again, steering is achieved by creating non co-linearity between the drill bit 11 and at least two other touch points. Examples of push-the-bit type rotary steerable systems, and how they operate are described in U.S. Pat. Nos. 5,265,682; 5,553,678; 5,803,185; 6,089,332; 5,695,015; 5,685,379; 5,706,905; 5,553,679; 5,673,763; 5,520,255; 5,603,385; 5,582,259; 5,778,992; 5,971,085 all herein incorporated by reference.

Refer now to FIG. 3, a conceptual illustration of a wellbore 2 is illustrated in an accordance with an embodiment of the present invention. In the present example, the wellbore 2 extends into the formation and terminates at a depth and position “A” in formation F1. The zone of interest or target is identified as point “T.” In this example, the target T is positioned in formation F2. It is noted that position A and target T may be within the same geological formation or in different formations as illustrated in FIG. 3. The target T may be the termination point of the wellbore 2 or a target between the current position A and the termination point of the wellbore 2. In an embodiment, the target T may be changing or moving. For example, the target T may be set a certain predetermined distance ahead of the drill bit 11. The target T may be a position on a predetermined geometric plan of the wellbore 2. The target T may also be manually selected by, for example, an operator, a geologist, an engineer or like individual related to the well system 100. The target T may be the ultimate target selected by the geologist, for example, and the methods and systems described herein may use intermediate targets, such as targets a predetermined distance ahead of the drill bit 11, to reach the ultimate target T.

According to an exemplary embodiment of the present invention, a method is provided that may be utilized to correct or provide a trajectory from the position A to the target T. Traditionally, the corrected trajectory is corrected in the most direct approach to strike the target T, specifically the minimum distance between the actual position and the target T. Examples of methods for planning the direction and inclination of a wellbore trajectory are provided in U.S. Pat. No. 6,757,613 which is incorporated herein by reference. In the present invention, the trajectory may be determined or corrected by selecting a trajectory based on one or more factors or considerations. In a preferred embodiment, the present invention provides a method for correcting the trajectory (or well plan) taking into consideration one or more factors. For example, in some embodiments, the corrected trajectory is selected from one of numerous possible trajectories by assigning a cost to each possible trajectory and selecting a trajectory based on a cost function analysis.

Because there are nearly an infinite number of paths from the position A to the target T, the factors or the considerations permit a selection of one of the paths that is preferably the optimal path based on those factors or considerations. FIG. 3 illustrates with hatched lines two examples of optional trajectories 28 and 30 extending from position A to target T. The optimal trajectory (or well plan) may be selected by the controller 19, a sub in the drill string 4, the communication module 18 or other sub or module in the BHA 10. Alternatively, the optimal trajectory may be selected at a location remote from the well bore 2 and the controller 19. For example, the trajectory or well plan may be selected at a remote location at the rig or at a remote location from the rig. In such an embodiment, the controller 19 may be used to communicate the optimal trajectory (or well plan) to the BHA 10.

The controller 19 may communicate instructions to the BHA 10, for example, to direct the BHA 10 and the drilling of wellbore 2 along the corrected optimal trajectory. A computer software program in a computer readable medium, for example, may be utilized to analyze the factors or considerations relating to the optimal trajectory and selecting the optimal trajectory. To this end, the optimal trajectory (or well plan) may be selected automatically without human intervention. The factors or considerations for selecting the optimal trajectory may be based on data received and/or stored relating to current drilling conditions and formation characteristics, historical drilling conditions and formation characteristics, predicted drilling conditions and formation characteristics, operating or drilling limitations and/or production considerations.

Drilling conditions and formation characteristics may include data related to formation evaluation properties, drilling measurements, such as depth, temperature, drilling fluid pressure, drilling fluid density and drilling fluid flow rate, rate of penetration, location of the drill bit and/or drill string, torque or drag related information or other drilling and formations measurements commonly known by those having ordinary skill in the art. Data from past drilling conditions may include data from other wellbores, such as wellbores at or near the wellsite, wellbores drilled with substantially similar tools, such as components of the BHA 10 and wellbores in which similar trajectory corrections were required. Predicted drilling conditions and formations characteristics may include, for example, torque and drag calculations for continued drilling. As an example, the possible trajectories may not only be analyzed for the torque and drag for reaching the target T but also the torque and drag for drilling the wellbore 2 from the target T to the termination of the wellbore 2 or to a subsequent target.

Examples of operating or drilling limitations may include limitations of the drill bit 11, the RSS 17, or any other component of the well system 100. Other examples of operating or drilling limitations include limitations related to the maximum dog-leg severity or the drilling fluid rates that may be utilized. For example, due to certain constraints or necessities the maximum or minimum flow rates may preclude an optional trajectory. Other examples of operating limitations include drill string turn radius and known build rate limitations. For example, based on past drilling data, it may be known that it is difficult to build more than 2°/100′ in a given wellbore of formation. Therefore, possible trajectories may be limited to those having build rates less than or equal to 2°/100′. Operating or drilling limitations may impact the actual trajectory that may be drilled and thus the optimal trajectory.

A production consideration may relate to selecting a trajectory that maximizes the amount of hydrocarbons that may be extracted from the reservoir over the life of the reservoir. An advantageous production consideration may be to provide the longest portion of the drill string 4 along a particular formation zone, for example a thin pay zone. In a horizontal well used to inject fluids to maintain pressure in the reservoir, for example, the production consideration may be maximizing the length of well drilled along a specific path that will permit maintaining reservoir pressure.

Possible trajectories may be selected by obtaining or inputting drilling considerations, such as minimizing dog-leg severity, minimizing torque and drag forces to reach the target T, minimizing predicted torque and drag forces for drilling beyond the target T, such as to the termination of the wellbore or to a subsequent point or target, maximizing rate of penetration, minimizing required drilling fluid flow rate, or other consideration related to drilling a wellbore appreciated by a person having ordinary skill in the art. The optimal trajectory may be selected from the possible trajectories by analyzing the data in view of the production considerations and/or the drilling considerations. One or more of the drilling considerations or the production considerations may be prioritized or a hierarchy of the data input as production and drilling considerations may be determined. In order to select the optimal trajectory, it may be required to analyze the data related to the wellbore, such as the drilling conditions and formation characteristics, historical drilling conditions and formation characteristics data, data related to predicted drilling conditions and formation characteristics. Possible trajectories may be eliminated by drilling limitations and further by the production or drilling considerations. The optimal path or trajectory may be the trajectory conforming to the drilling limitations while maximizing the production or drilling considerations. In an embodiment, the optimal trajectory may be the trajectory conforming to the drilling limitations and best satisfying a hierarchy or prioritized production consideration or drilling consideration.

In an example, as shown in FIG. 3, the trajectories 28 and 30 may be optional trajectories based on drilling and formation considerations and production considerations. The trajectories 28 and 30 may be reviewed based on the operating and drilling limitations, for example, dog-leg severity and torque and drag. In this example, it may be determined that the trajectory 28 and the trajectory 30 are within the maximum dog-leg severity possible based on the operating and drilling limitations as well as the formation limitations. The trajectory 28 provides the least severe dog-leg severity and minimizes the friction or drag for moving the drill string 4 forward relative to the trajectory 30. Therefore, if drag to the target T is the primary consideration, then the trajectory 28 may be selected.

The trajectories 28, 30 may be reviewed based on a second operating and drilling limitation, such as, build rate. Data recorded from drilling to the position A may indicate that only a minimal build rate has been achieved in reaching the position A. Therefore, based on the drilling data obtained and analyzed it may be determined that the trajectory 30 provides a path to the target T that is within the drilling limitations encountered. Accordingly, in this example, the trajectory 30 may be selected as the optimal trajectory for striking target T. As illustrated in this example, the trajectory 28 may have been a traditionally selected and planned path and may have resulted in wellbore 2 failing to strike target T due to the drilling limitation of the particular installation. It is noted that the proposed and optimal trajectories are primarily described in regard to the path extending from the position A to the target T. However, it should be recognized that although the target T may be an ultimate goal it may also be described as a short range target. Alternatively, it is recognized that the trajectories may be analyzed and selected in sections so as to achieve the optimal overall trajectory.

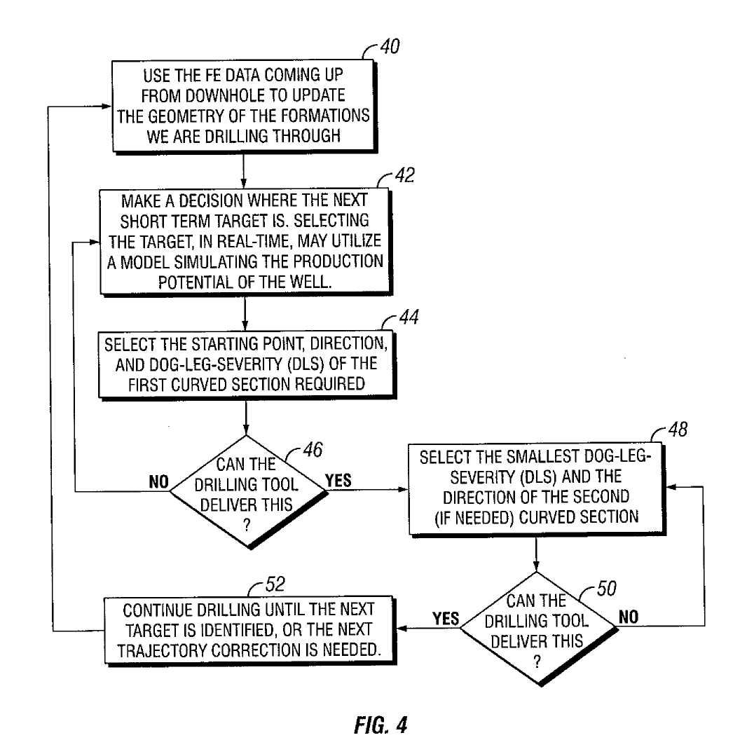

Refer now to FIG. 4 wherein a block diagram illustrates one method for optimizing a wellbore trajectory while drilling in accordance with an embodiment of the present invention. The method is described with reference to FIGS. 1-4.

In step 40, the formation evaluation data received from BHA 10 is utilized by controller 19 to update the geometry of formation F1 (FIG. 3). In step 42, a short range target, illustrated at “B” in FIG. 3, is selected. In this example, the short range target is selected to incorporate a curved section or turn to orient the trajectory toward target T. Various parameters may be utilized to select a short range target and in some embodiments a short range or term target may not be utilized. In step 44, a starting position A, direction, and dog-leg-severity (DLS) of the projected trajectory section from A to B is determined and selected for analysis. For example, the characteristics of step 44 are selected for each of proposed trajectory 28 and 30 in the example of FIG. 3 for analysis. In step 46, the proposed trajectory section is analyzed in view of the operational drilling limitations and considerations for feasibility. Referring to the description of FIG. 3 above, the drilling system did not preclude achieving the dog-leg of section A-B. In step 48, the trajectory having the least severe DLS may be chosen. In the example of FIG. 3, trajectory 28 is chosen based on section A-B. In this example, step 48 may also include or proceed to the step of selecting a next trajectory section, for example section B-T in FIG. 3. The additional step of 48 may further include analysis of section A-B based on other drilling or formation parameters. In step 50, section B-T is analyzed for the selected trajectory 28. As described above with reference to FIG. 3, the drilling data received from BHA 10 indicated that the drilling system may not achieve the build rate necessary to steer bit 11 and thus wellbore 2 along section B-T of trajectory 28. In this example, trajectory 30 would be analyzed and determined to be achievable (described with reference to FIG. 3 above). Therefore, in selecting an optimal trajectory extending from A to target T, trajectory 30 is selected as the real-time trajectory to follow. Step 52 may represent steps performed in various configurations of the method. For example, in initially evaluating and selecting an optimal trajectory, step 52 comprises subsequent selected section selections and analysis. During drilling, step 52 may represent continuous evaluation and when necessary correction of the trajectory.

As noted, from time to time herein a trajectory is referred to as a real-time trajectory. The term, real-time trajectory is utilized herein to generally describe the dynamic nature of the trajectory pursuant to the methods described. For example, traditionally a predetermined trajectory is planned and provided. However, for various reasons the wellbore may not be drilled along the trajectory. The present method provides selection of a trajectory that is selected in real-time as the wellbore is being drilled so that the selected target can be achieved in an optimal manner. Thus, the trajectory, referred to herein as a real-time trajectory, may be continuously changed based on the actual ability to position the drill bit and wellbore and/or a change in desired target. It is further noted, that real-time trajectory and related terms are used to indicate the proposed or desired path for the wellbore to be drilled and is not used in hindsight to refer to wellbore that has been drilled.

From the foregoing detailed description of specific embodiments of the invention, it should be apparent that a system for optimizing a trajectory of a wellbore in real-time that is novel has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. A method for selecting a trajectory of a wellbore while drilling the wellbore comprising the steps of:
obtaining data related to the wellbore;
obtaining data related to one or more drilling limitation or production consideration;
selecting a target within the wellbore;
reviewing possible trajectories based on the drilling limitation or the production consideration; and
selecting an optimal trajectory to the target based on the drilling limitation or the production consideration.

2. The method of claim 1 wherein the production consideration includes maximizing amounts of hydrocarbons capable of being produced by the wellbore.

3. The method of claim 1 wherein the drilling limitation includes build rate.

4. The method of claim 1 wherein the optimal trajectory is based on the drilling limitation and the production consideration.

5. The method of claim 1 wherein the optical trajectory is automatically selected without human intervention.

6. The method of claim 1 wherein the optimal trajectory has the least torque and drag forces of any of the possible trajectories.

7. The method of claim 1 wherein the optimal trajectory minimizes predicted torque and drag forces for drilling the wellbore beyond the target.

8. The method of claim 1 wherein the production consideration includes maximizing the length of the wellbore positioned in a formation zone of interest.

9. The method of claim 1 wherein the drilling limitation includes a maximum trajectory and the optimal trajectory minimizes dog-leg-severity.

10. A computer program in a computer readable medium for optimizing a trajectory of a wellbore comprising:
instructions for obtaining downhole data obtained while drilling the wellbore;
instructions for selecting a target;
instructions for optimizing a drilling consideration or a production consideration;
instructions for analyzing one or more possible trajectories based on a drilling limitation; and
instructions for selecting an optimal trajectory based on the drilling consideration or the production consideration, wherein the optimal trajectory is within the drilling limitation.

11. The computer program of claim 10 wherein the drilling limitation includes at least one of maximum dog-leg severity, maximum build rate, or drilling fluid flow rate.

12. The computer program of claim 11 wherein the production consideration includes maximizing an amount of hydrocarbons capable of being produced by the wellbore.

13. The computer program of claim 12 wherein the drilling consideration includes one of minimizing torque and drag forces for drilling the wellbore beyond the target or minimizing dog-leg severity.

14. The computer program of claim 13 wherein the computer program analyzes possible trajectories and automatically selects the optimal trajectory.

15. The computer program of claim 14 wherein the optimal trajectory is automatically selected by prioritizing on one of the drilling consideration or the production consideration.

16. A method for selecting a trajectory of a wellbore while drilling the wellbore comprising the steps of:
obtaining real-time data related to the wellbore;
obtaining data related to drilling limitations;
obtaining data related to production considerations and drilling considerations;
selecting a target within the wellbore;
automatically selecting an optimal trajectory from possible trajectories to the target, wherein the optimal trajectory conforms with the drilling limitations and satisfies one or more of the production considerations or drilling considerations.

17. The method of claim 16, wherein the drilling consideration includes minimizing predicted torque and drag forces beyond the target.

18. The method of claim 17, wherein the drilling consideration includes minimizing dog-leg-severity.

19. The method of claim 17 wherein the drilling limitation includes a maximum build rate.

20. The method of claim 19 wherein the production consideration and the drilling considerations are prioritized.
